(19) United States
(12) Patent Application Publication
(10) Pub. No.: US 2026/0355921 A1
(43) Pub. Date: Nov. 12, 2026

(54) Drill hammer or chisel hammer with a vibration-decoupled device housing

(71) Applicant: Hilti Aktiengesellschaft, Schaan (LI)

(72) Inventors: Steffen GEIGER, Muenchen (DE); Adrian STEINGRUBER, Schwabmünchen (DE)

(21) Appl. No.: 19/103,008

(22) PCT Filed: Aug. 2, 2023
(86) PCT No.: PCT/EP2023/071438

§ 371 Date: Feb. 11, 2025

(30) Foreign Application Priority Data
Aug. 29, 2022 (EP) 22192581.1

(51) Int. Cl. B25D 17/24

(52) U.S. Cl. CPC B25D 17/24; B25D 2222/57; B25D 2250/121

(57) ABSTRACT

A drill hammer or chisel hammer with a device housing for the vibration-decoupled accommodation of an axial impact unit, including a hammer mechanism, provided with a drive motor, for generating a linear alternating working movement, which can be transmitted to a chisel tool via an end-side tool receiving unit, wherein the axial impact unit is guided along the axial working movement direction via at least one front sliding guide arranged in the region of the hammer mechanism and via at least one rear sliding guide arranged in the region of the drive motor, and is vibration-decoupled by at least one decoupling spring which is also operatively arranged in the working movement direction between the device housing and the axial impact unit, wherein the rear sliding guide includes at least one U-shaped profiled guide rail on the housing side, in which at least one guide block corresponding thereto on the impact unit side is guided.

The invention relates to a drill hammer or chisel.

The field of application of the invention extends primarily to a hand-held chisel hammer, which is preferably operated via an electric drive. Most preferably, a chisel hammer of the type of interest here has a center of gravity located in the region of the hammer mechanism axis. For this purpose, the drive motor, transmission, hammer mechanism, and tool receiving unit components are arranged coaxially to the hammer mechanism axis. Apart from being used with a chisel hammer, it is also conceivable to use the solution according to the invention with a drill hammer in which a linear alternating working movement is superimposed with a rotary movement for a drill hammer as the tool.

### BACKGROUND

A chisel hammer of the type of interest here emerges from the generally known prior art, which, as regards the axial impact unit accommodated in a device housing in a vibration-decoupled manner, is equipped with a so-called sub-chassis decoupling that allows a relative movement of the internal active unit relative to the device housing, which surrounds said unit, in the working movement direction. For this purpose, the vibration decoupling usually comprises a front sliding guide which surrounds the hammer mechanism and is arranged axially adjacent to the outer tool receiving unit. For example, a sliding sleeve arrangement may be used for this purpose. This front sliding guide interacts with a rear sliding guide, which is usually arranged at the same level as the drive motor and there establishes a connection between the axial impact unit and the surrounding device housing. The sliding guide arrangement consisting of the front and rear sliding guides enables a relative movement of the axial impact unit relative to the device housing over a stroke path along the axial working movement direction. The sliding guide arrangement is completed by at least one decoupling spring also acting in the working movement direction and arranged between the device housing and the hammer mechanism, which decoupling spring is usually designed in the manner of a leaf spring.

### SUMMARY OF THE INVENTION

The spring travel that can be achieved thereby is quite limited due to the design and installation space. A high-grade spring steel is required in order to achieve a functioning of the leaf spring that is permanently elastic over its service life. However, the leaf spring usually acts only partially as a spring in the impact axis direction. Its main task is rather to suspend the axial impact unit in the device housing. Therefore, an additional compression spring is usually required in order to achieve the required stiffness in the impact axis direction.

It is an object of the present invention to improve a drill hammer or chisel hammer of the generic type such that a reliable and effective vibration decoupling is realized with little technical effort.

The present invention provides a drill hammer or chisel hammer with a device housing (1) for the vibration-decoupled accommodation of an axial impact unit, comprising a hammer mechanism (4), provided with a drive motor (3), for generating a linear alternating working movement, which can be transmitted to a chisel tool via an end-side tool receiving unit (5), wherein the axial impact unit is guided along the axial working movement direction via at least one front sliding guide (6) arranged in the region of the hammer mechanism (4) and via at least one rear sliding guide (9a, 9b) arranged in the region of the drive motor (3), and is vibration-decoupled by at least one decoupling spring (10) which is also operatively arranged in the working movement direction between the device housing (1) and the axial impact unit, characterized in that the rear sliding guide (9a, 9b) comprises at least one U-shaped profiled guide rail (11) on the housing side, in which at least one guide block (12) corresponding thereto on the impact unit side is guided.

The invention includes the technical teaching that, in the case of a drill hammer or chisel hammer with a front and rear sliding guide, the rear sliding guide comprises at least one U-shaped profiled guide rail on the housing side, in which at least one guide block corresponding thereto on the impact unit side is guided. According to a preferred embodiment, exactly one front sliding guide and two rear sliding guides are provided, which are arranged opposite one another laterally on the axial impact unit preferably at the drive level-in order to ensure a reliably permanent sliding guidance in the working movement direction via a minimum number of guide points.

The advantage of the solution according to the invention is in particular that, thanks to the simply designed guide elements, a correspondingly simple manufacture and assembly on the part of the device housing or hammer mechanism is possible. In addition, from a structural point of view, the guide principle allows for using decoupling springs with long spring travels—preferably pressure, helical, or barrel springs. As experiments have shown, a vibration decoupling with values of below 5 m/s² can be achieved thereby. Such a decoupling spring/sliding guide combination allows for a relatively long stroke path, whereby a comfortable vibration decoupling can be achieved. This enables a design for an optimal stroke path.

According to a measure further improving the invention, it is provided for the guide block to be provided with elastomer elements on both sides in the direction of movement, which interact with respective stop portions corresponding thereto of the device housing. As a result, a smooth, two-sided end stop is realized in the event that the maximum bump and rebound stroke is reached. As regards the bump stroke, this buffered end stop prevents the spring windings of the decoupling spring from overlapping one another, which would result in a hard shock pulse and, in extreme cases, could damage the decoupling spring or the adjacent components. In the normal state, in which the decoupling spring is relaxed, the front elastomer element comes to bear against the associated stop portion of the device housing under pretension, in order, in particular, to allow a fixed chisel tool to be comfortably pulled out.

According to a preferred embodiment of the guide block, which preferably has a T-shaped side view, a pin portion is provided in its foot region, whereby the guide block can be inserted so as to fit into a corresponding blind bore of the axial impact unit. Subsequently, the inserted guide block can be detachably fastened to the axial impact unit with a screw and via a through bore that preferably extends coaxially to the pin portion. In this case, the through bore for realizing the screw connection is arranged on the T-shaped guide block such that it does not impede the elastomer elements on both sides which are preferably inserted therein. Moreover, a single and thus central screw connection is sufficient to reliably fasten the guide block. Furthermore, this central screw connection ensures a certain pivotability of the guide block about its longitudinal axis, so that the guide block can automatically align with respect to the guide path provided by the guide rail. This prevents friction wear on the guide block flanks, which would otherwise arise due to a grinding of the latter on the guide rail. This would result in an unwanted larger guide clearance, which is prevented in a simple manner thanks to the central screw connection.

In contrast, the guide rail on the housing side is preferably clipped or pressed into a corresponding device structure without fixing means. For this purpose, the guide rail preferably has, on at least one rail end, a flat insertion tab, integrally formed on the base portion on the end side, which engages in a corresponding holding structure on the inside of the device housing. This prevents, in a simple manner, a captive mounting of the guide rail mounted by clipping or pressing.

According to a preferred embodiment, the U-shaped profiled guide rail is produced as a sheet-metal part. It preferably consists of a stainless steel material in order to enable optimal sliding of the guide block as friction partner. The guide block can be designed as an injection-molded part, which consists, for example, of a PAG plastic.

### BRIEF DESCRIPTION OF THE DRAWINGS

Further measures improving the invention are explained in more detail below together with the description of a preferred exemplary embodiment of the invention with reference to the figures. In the drawings:

FIG. 1 shows a longitudinal section through a chisel hammer with a front and rear sliding guide for the vibration-decoupled accommodation of an axial impact unit

FIG. 2 shows a perspectival view of a guide rail, on the housing side, of the rear sliding guide, and

FIG. 3 shows a perspectival view of a guide block, on the impact unit side, of the rear sliding guide.

### DETAILED DESCRIPTION

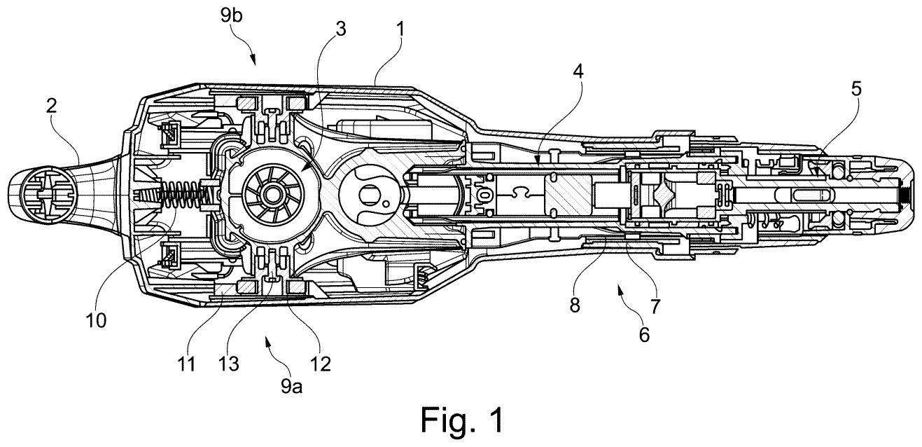

According to FIG. 1, a chisel hammer has a device housing 1 consisting of plastic with a handle 2 formed at the rear for manual handling of the device. The device housing 1 accommodates an axial impact unit, comprising an electric drive motor 3 and a hammer mechanism 4 known per se which converts the rotational movement of the drive motor 3 into a linear alternating working movement for a chisel tool. For this purpose, a tool receiving unit 5 arranged at the end of the hammer mechanism 4 is provided. The axial impact unit with the drive motor 3, hammer mechanism 4, and tool receiving unit 5 are arranged along the same hammer mechanism axis.

The internal axial impact unit is guided via a front sliding guide 6 arranged in the region of the hammer mechanism 4 and composed of an outer guide ring 7 on the housing side and an inner guide ring 8 on the impact unit side which is surrounded by the outer guide ring 7. In this way, two rear sliding guides 9a and 9b, arranged at the same level as the drive motor 3, interact and are arranged opposite one another laterally on the axial impact unit.

A decoupling spring 10 designed as a compression spring is arranged between the device housing 1 in the region of the handle and the proximal end of the axial impact unit—here, specifically its drive motor 3. The decoupling spring 10 ensures a vibration decoupling acting in the working movement direction, the stroke path of which in the axial working movement direction is made possible by the sliding guide means described above.

The two rear sliding guides 9a and 9b are constructed identically and each consist of a guide rail 11 on the housing side in which a guide block 12, which corresponds thereto, is guided along the working movement direction. The guide block 12 is inserted into a recess in the drive motor 3 of the axial impact unit and is fastened by means of a screw 13. In contrast, the guide rail 11 is clipped into a corresponding housing structure of the device housing 1.

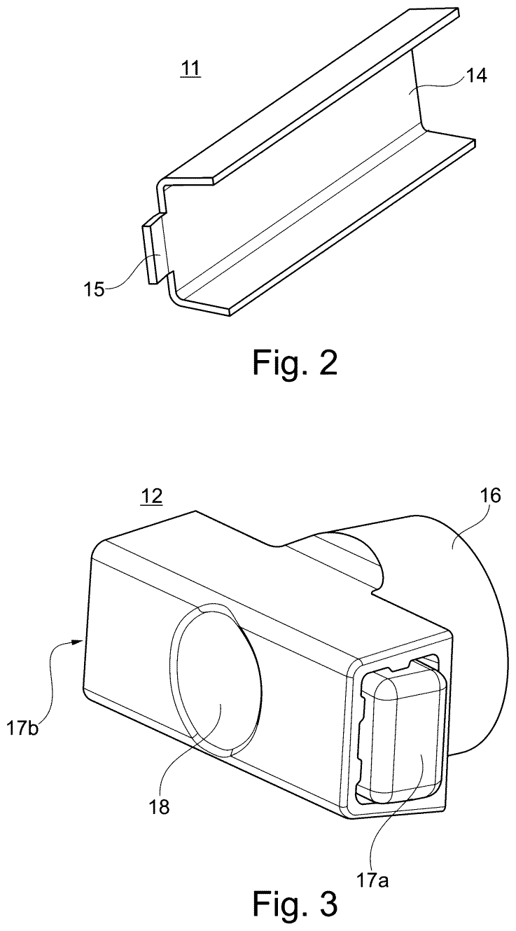

According to FIG. 2, the U-shaped profiled guide rail 11 on the housing side has a flat plug-in tab 15, formed on the end side of the base portion 14, for clipping into the corresponding housing structure of the device housing (shown here solely schematically as HS). The U-shaped profiled guide rail 11 is designed as a sheet-metal part made of a stainless steel sheet.

The guide block 12 shown in FIG. 3 and corresponding as a friction partner to the guide rail 11 has a T-shaped side view, the foot region of which is designed as a cylindrical pin portion 16 in order to be inserted so as to fit into the aforementioned corresponding recess on the axial impact unit.

Moreover, the guide block 12 is provided with end-side elastomer elements 17a and 17b in the leg region on both sides, which elastomer elements 17a and 17b interact, as an end stop, with the above-mentioned stop portions on the device housing. Owing to the illustration, the second elastomer element 17b is shown concealed.

Moreover, the guide block 12 has a through bore 18 extending coaxially to the pin portion 16 for realizing the screw connection described above. The through bore 18 is a counterbore in order to provide the screw connection in a concealed manner by means of a hexagon socket screw or the like. Incidentally, the guide block 12 is made of an injection-molded plastic material.

The invention is not limited to the preferred exemplary embodiment described above. Rather, modifications thereof are also conceivable, which are covered by the scope of protection of the following claims. For example, it is also possible to use the solution according to the invention with a drill hammer. Also, the embodiment of the decoupling spring is not limited solely to a compression spring made of steel. For example, elastomer springs, air springs, or the like can also be used for this purpose.

### LIST OF REFERENCE SIGNS

1 Device housing
2 Handle
3 Drive motor
4 Hammer mechanism
5 Tool receiving unit
6 Front sliding guide
7 Outer sliding sleeve
8 Inner sliding sleeve
9 Rear sliding guide
10 Decoupling spring
11 Guide rail
12 Guide block
13 Screw
14 Base portion
15 Insertion tab
16 Pin portion
17 Elastomer element
18 Through bore

What is claimed is:

1-10. (canceled)

11. A drill hammer or chisel hammer comprising:
a device housing;
an axial impact unit, the device housing for vibration-decoupled accommodation of the axial impact unit, the axial impact unit including a drive motor and a hammer mechanism for generating a linear alternating working movement transmittable to a chisel tool via an end-side tool receiving unit, the axial impact unit being guided along the axial working movement direction via at least one front sliding guide arranged in a region of the hammer mechanism and via at least one rear sliding guide arranged in a region of the drive motor, and being vibration-decoupled by at least one decoupling spring operatively arranged in the working movement direction between the device housing and the axial impact unit, the rear sliding guide including at least one U-shaped profiled guide rail on the housing side; and
at least one guide block on the impact unit side being guided in the U-shaped profiled guide.

12. The drill hammer or chisel hammer as recited in claim 11 wherein the guide block has end-side elastomer elements interacting with respective stop portions of the device housing.

13. The drill hammer or chisel hammer as recited in claim 11 wherein the guide block has a rear pin portion inserted into a corresponding recess of the axial impact unit.

14. The drill hammer or chisel hammer as recited in claim 13 wherein the guide block is fastened to the axial impact unit via a screw and a through bore extending coaxially to the pin portion.

15. The drill hammer or chisel hammer as recited in claim 11 wherein the guide rail on the housing side is clipped or pressed into a corresponding housing structure of the device housing without a separate fixing device.

16. The drill hammer or chisel hammer as recited in claim 11 wherein the guide rail has at least one rail end with a flat insertion tab integrally formed on the base portion on the end side.

17. The drill hammer or chisel hammer as recited in claim 11 wherein the U-shaped profiled guide rail is designed as a sheet-metal part.

18. The drill hammer or chisel hammer as recited in claim 17 wherein the guide block is designed as a plastic injection-molded part.

19. The drill hammer or chisel hammer as recited in claim 11 wherein the guide block is designed as a plastic injection-molded part.

20. The drill hammer or chisel hammer as recited in claim 11 wherein the drive motor, the hammer mechanism, and the tool receiving unit are arranged along a same hammer mechanism axis.

21. The drill hammer or chisel hammer as recited in claim 11 wherein the at least one front sliding guide numbers exactly one front sliding guide and the at least one rear sliding guide numbers exactly two rear sliding guides arranged opposite one another laterally on the axial impact unit.
